(19) United States
(12) Patent Application Publication
(10) Pub. No.: US 2026/0197904 A1
(43) Pub. Date: Jul. 9, 2026

(54) INFRARED HEATER

(71) Applicant: NGK INSULATORS, LTD., Nagoya (JP)

(72) Inventor: Yudai KONO, Nagoya-shi (JP)

(21) Appl. No.: 19/556,079

(22) Filed: Mar. 4, 2026

Related U.S. Application Data
(63) Continuation of application No. PCT/JP2024/021525, filed on Jun. 13, 2024.

(30) Foreign Application Priority Data
Sep. 5, 2023 (JP) 2023-143888

(51) Int. Cl. H05B 3/26

(52) U.S. Cl. CPC H05B 3/26; H05B 2214/04

(57) ABSTRACT

An infrared heater includes: a dielectric layer; a conductor pattern including a plurality of first conductor portions; and a second conductor portion. The plurality of first conductor portions are arrayed so as to be spaced apart from each other to form a periodic structure. The plurality of first conductor portions each include a first adhesive layer, a first barrier layer, and a first body layer. The first adhesive layer is in contact with the dielectric layer. The first body layer is arranged on a side of the first adhesive layer opposite to the dielectric layer. The first barrier layer is arranged between the first adhesive layer and the first body layer. The first barrier layer is capable of barring a material for forming the first adhesive layer from migrating into the first body layer.

### CROSS-REFERENCE TO RELATED APPLICATIONS

This application is a continuation of International Application PCT/JP2024/021525, filed on Jun. 13, 2024, which claims the benefit of Japanese Application No. 2023-143888 filed on Sep. 5, 2023, the entire contents of which are incorporated herein by reference.

### BACKGROUND OF THE INVENTION

### 1. Field of the Invention

The present disclosure relates to an infrared heater.

### 2. Description of the Related Art

An infrared heater that emits infrared light has been heretofore known. It has been desired that such infrared heater emit infrared light in a narrow wavelength band in order to efficiently impart energy to an object. For example, there is a proposal of an infrared heater including a heat generator and a structural body having an infrared light emitting surface, in which the structural body includes a first conductor layer including a plurality of individual conductor layers for forming a periodic structure, an adhesive layer, a dielectric layer, and a second conductor layer in this order (see, for example, Patent Literature 1). In such infrared heater, when the structural body absorbs energy from the heat generator, infrared light having a maximum peak of a half width of 1.5 μm or less and an emissivity value of 0.8 or more is emitted.

In recent years, enhancement in radiation energy intensity of infrared light emitted from an infrared heater has been desired. In view of the foregoing, in the infrared heater described in Patent Literature 1, an attempt has been made to heat the structural body to a higher temperature (e.g., 400° C. or more) to enhance the radiation energy intensity of infrared light. Accordingly, improvement in heat resistance of the infrared heater has been expected so that an operation in a high-temperature range is enabled.

### CITATION LIST

### Patent Literature

[PTL 1] JP 2017-50254 A

### SUMMARY OF THE INVENTION

A primary object of the present disclosure is to provide an infrared heater having excellent heat resistance.
[1] According to one embodiment of the present disclosure, there is provided an infrared heater, including: a dielectric layer; a conductor pattern including a plurality of first conductor portions; and a second conductor portion. The conductor pattern is arranged on the dielectric layer. The plurality of first conductor portions are arrayed so as to be spaced apart from each other to form a periodic structure. The second conductor portion is arranged on a side of the dielectric layer opposite to the conductor pattern. The plurality of first conductor portions each include a first adhesive layer, a first barrier layer, and a first body layer. The first adhesive layer is in contact with the dielectric layer. The first body layer is arranged on a side of the first adhesive layer opposite to the dielectric layer. The first barrier layer is arranged between the first adhesive layer and the first body layer. The first barrier layer is capable of barring a material for forming the first adhesive layer from migrating into the first body layer.
[2] In the infrared heater according to the above-mentioned item [1], the first barrier layer may have a thickness of 0.2 nm or more and 50 nm or less.
[3] In the infrared heater according to the above-mentioned item [1] or [2], a material for forming the first barrier layer may contain a platinum group element and/or an oxide thereof.
[4] In the infrared heater according to any one of the above-mentioned items [1] to [3], the second conductor portion may include a second adhesive layer, a second barrier layer, and a second body layer. The second adhesive layer is in contact with the dielectric layer. The second body layer is arranged on a side of the second adhesive layer opposite to the dielectric layer. The second barrier layer is arranged between the second adhesive layer and the second body layer. The second barrier layer is capable of barring a material for forming the second adhesive layer from migrating into the second body layer.
[5] The infrared heater according to the above-mentioned item [4] may further include a support substrate. The support substrate is arranged on a side of the second conductor portion opposite to the dielectric layer.
[6] In the infrared heater according to the above-mentioned item [5], the second conductor portion may further include a third adhesive layer and a third barrier layer. The third adhesive layer is in contact with the support substrate. The third barrier layer is arranged between the third adhesive layer and the second body layer. The third barrier layer is capable of barring a material for forming the third adhesive layer from migrating into the second body layer.
[7] In the infrared heater according to any one of the above-mentioned items [1] to [6], the plurality of first conductor portions may each have a thickness of 30 nm or more and 200 nm or less. When the plurality of first conductor portions each have a rectangular shape when viewed from a thickness direction, the plurality of first conductor portions may each have a side with a length of 500 nm or more and 8,000 nm or less. When the plurality of first conductor portions each have a circular shape when viewed from the thickness direction, the plurality of first conductor portions may each have a diameter of 500 nm or more and 8,000 nm or less.
[8] In the infrared heater according to any one of the above-mentioned items [1] to [7], a distance between adjacent first conductor portions among the plurality of first conductor portions may be 300 nm or more and 4,000 nm or less.
[9] The infrared heater according to any one of the above-mentioned items [1] to [8] may further include a heating unit. The heating unit is capable of heating a metamaterial structure including the dielectric layer, the plurality of first conductor portions, and the second conductor portion.
[10] In the infrared heater according to the above-mentioned item [9], the metamaterial structure may be configured such that a resonance phenomenon based on magnetic polariton occurs through heating with the heating unit. The infrared heater may be capable of emitting infrared light having a maximum peak of a normal emissivity of 0.8 or more. A peak wavelength of the maximum peak may be 2 μm or more and 10 μm or less. A half width of the maximum peak may be 1.5 μm or less.

According to the embodiment of the present disclosure, the infrared heater having excellent heat resistance can be achieved.

### BRIEF DESCRIPTION OF THE DRAWINGS

FIG. 1 is a schematic sectional view of an infrared heater according to one embodiment of the present disclosure.

FIG. 2 is a sectional view of a first conductor portion in FIG. 1 taken along the line II-II′.

FIG. 3A is a schematic sectional view for describing a step of preparing a support substrate in a method of producing an infrared heater according to one embodiment of the present disclosure.

FIG. 3B is a schematic sectional view for describing a step of forming a second conductor portion on the support substrate in FIG. 3A.

FIG. 3C is a schematic sectional view for describing a step of forming a dielectric layer on the second conductor portion in FIG. 3B.

FIG. 3D is a schematic sectional view for describing a step of forming a resist pattern on the dielectric layer in FIG. 3C.

FIG. 3E is a schematic sectional view for describing a step of forming a conductor pattern on the dielectric layer via the resist pattern in FIG. 3D.

FIG. 4 is a graph showing infrared emissivity curves of an infrared heater of Example 2 before and after a heat durability test.

FIG. 5 is a graph showing infrared emissivity curves of an infrared heater of Comparative Example 2 before and after the heat durability test.

FIG. 6 is a graph showing infrared emissivity curves of the infrared heater of Example 2 before and after the heat durability test.

FIG. 7 is a graph showing infrared emissivity curves of an infrared heater of Example 3 before and after the heat durability test.

FIG. 8 is a graph showing infrared emissivity curves of an infrared heater of Example 4 before and after the heat durability test.

FIG. 9 is a scanning electron microscope (SEM) photograph of a first conductor portion of the infrared heater of Example 2 before the heat durability test.

FIG. 10 is a SEM photograph of the first conductor portion of the infrared heater of Example 2 after the heat durability test of 500 hours.

FIG. 11 is a SEM photograph of a first conductor portion of the infrared heater of Example 3 after the heat durability test of 500 hours.

FIG. 12 is a SEM photograph of a first conductor portion of the infrared heater of Example 4 after the heat durability test of 500 hours.

### DESCRIPTION OF THE EMBODIMENTS

Embodiments of the present disclosure are described below with reference to the drawings. However, the present disclosure is not limited to these embodiments. In addition, in the drawings, the width, thickness, shape, and the like of each portion may be schematically illustrated as compared to those in the embodiments in order to provide clearer description, but the drawings are merely examples and do not limit the interpretation of the present disclosure.

### A. Overview of Infrared Heater

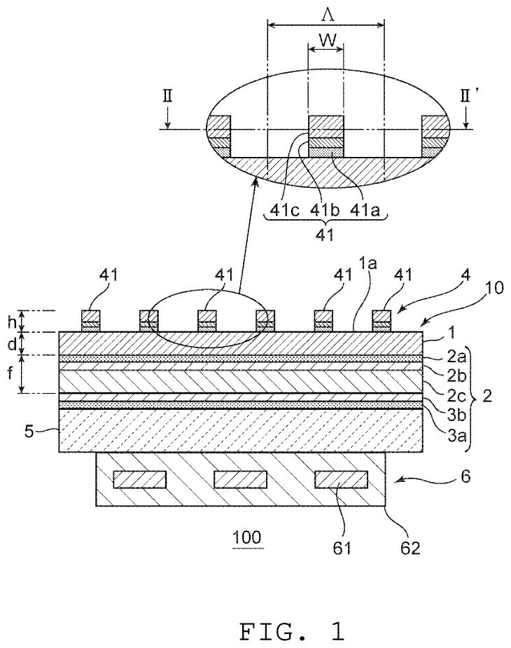

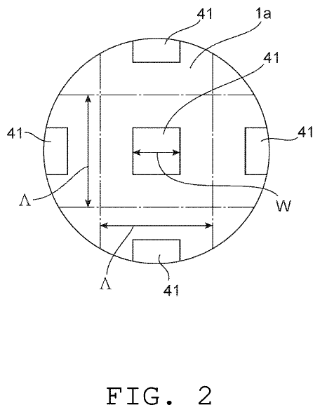

FIG. 1 is a schematic sectional view of an infrared heater according to one embodiment of the present disclosure, and FIG. 2 is a sectional view of a first conductor portion in FIG. 1 taken along the line II-II′. Hatching is omitted for convenience in FIG. 2.

An infrared heater 100 of the illustrated example is capable of emitting infrared light of a controlled wavelength, more specifically, infrared light of the wavelength (hereinafter referred to as “peak wavelength”) controlled to exhibit a maximum normal emissivity. That is, the infrared heater 100 typically functions as a wavelength-controlled heater.

As illustrated in FIG. 1, the infrared heater 100 includes: a dielectric layer 1; a conductor pattern 4 including a plurality of first conductor portions 41; and a second conductor portion 2. The conductor pattern 4 is arranged on the dielectric layer 1. The plurality of first conductor portions 41 are arrayed so as to be spaced apart from each other to form a periodic structure. The second conductor portion 2 is arranged on a side of the dielectric layer 1 opposite to the conductor pattern 4.

The plurality of first conductor portions 41 each include a first adhesive layer 41a, a first barrier layer 41b, and a first body layer 41c. The first adhesive layer 41a is in contact with the dielectric layer 1. The first body layer 41c is arranged on a side of the first adhesive layer 41a opposite to the dielectric layer 1. The first barrier layer 41b is arranged between the first adhesive layer 41a and the first body layer 41c. The first barrier layer 41b is capable of barring a material for forming the first adhesive layer 41a from migrating into the first body layer 41c.

The inventors have found that when an infrared heater is operated in a high-temperature range (e.g., 400° C. or more), the maximum emissivity of infrared light emitted from the infrared heater gradually decreases. In view of the foregoing, the inventors have made extensive investigations to improve the heat resistance of the infrared heater, and as a result, have found that the heat resistance of the infrared heater can be sufficiently improved by arranging the first barrier layer between the first adhesive layer and the first body layer in each of the first conductor portions. More specifically, when the first barrier layer is arranged between the first adhesive layer and the first body layer, the first barrier layer can suppress migration of a material for forming the first adhesive layer into the first body layer. In this way, even when the infrared heater is operated in a high-temperature range, migration of the material for forming the first adhesive layer into the first body layer to form an oxide film on the first body layer can be suppressed. Accordingly, the infrared heater can be operated in a high-temperature range over a long period of time, and infrared light with an excellent maximum normal emissivity can be stably emitted. The infrared heater 100 as described above can be suitably operated in a temperature range of, for example, 10° C. or more and 600° C. or less, or for example, 650° C. or more and 800° C. or less, or for example, 400° C. or more and 1,000° C. or less.

In the illustrated example, the plurality of first conductor portions 41, the dielectric layer 1, and the second conductor portion 2 form a metamaterial structure 10. The metamaterial structure 10 is typically configured such that a resonance phenomenon based on magnetic polariton occurs. When the resonance phenomenon occurs, a strong electromagnetic field confinement effect may be obtained in the dielectric layer 1 between the plurality of first conductor portions 41 and the second conductor portion 2. In this way, a portion of the dielectric layer 1 sandwiched by each of the first conductor portions 41 and the second conductor portion 2 functions as an infrared light radiation source. Then, infrared light of a controlled peak wavelength is emitted from a portion (hereinafter referred to as “emitting surface 1a”) of a surface of the dielectric layer 1 on which the plurality of first conductor portions 41 are not arranged, and travels around the plurality of first conductor portions 41.

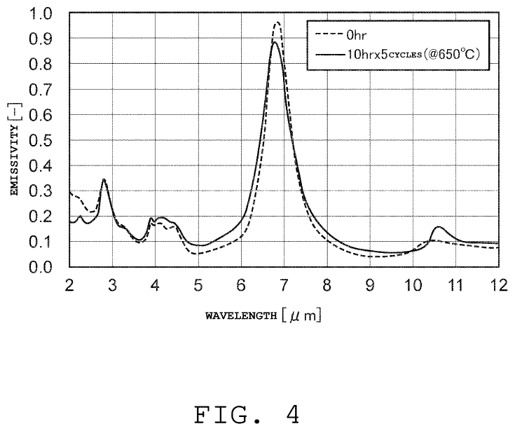

In one embodiment, the infrared heater 100 can emit infrared light having a maximum peak of a normal emissivity of 0.80 or more. The maximum peak is determined from an infrared emissivity curve (see FIG. 4) obtained by plotting normal emissivity versus wavelength of the infrared light, for example.

A peak wavelength of the maximum peak is located within the range of, for example, 2.0 μm or more and 10 μm or less, or is located within the range of, for example, 3.0 μm or more and 7.0 μm or less.

The normal emissivity of the maximum peak is preferably 0.85 or more, more preferably 0.90 or more. Meanwhile, an upper limit of the normal emissivity of the maximum peak is typically 1.0. The normal emissivity of the infrared light is calculated by the following formula (1) obtained by applying Kirchhoff's law assuming that a transmittance value is 0, for example. A normal reflectance is measured with a Fourier transform infrared spectrophotometer (FT-IR) equipped with an integrating sphere, for example.

$$( Normal emissivity ) = 1 - ( Normal reflectance ) \qquad ( 1 )$$

A half width of the maximum peak is, for example, 1.5 μm or less, preferably 1.0 μm or less. Meanwhile, a lower limit of the half width of the maximum peak is typically 0 μm.

In the infrared emissivity curve described above, it is preferred that no peak with a normal emissivity of 0.2 or more be present in a wavelength region other than the wavelength region from rising to falling of the maximum peak.

In one embodiment, the second conductor portion 2 includes a second adhesive layer 2a, a second barrier layer 2b, and a second body layer 2c. The second adhesive layer 2a is in contact with the dielectric layer 1. The second body layer 2c is arranged on a side of the second adhesive layer 2a opposite to the dielectric layer 1. The second barrier layer 2b is arranged between the second adhesive layer 2a and the second body layer 2c. The second barrier layer 2b is capable of barring a material for forming the second adhesive layer 2a from migrating into the second body layer 2c.

According to such configuration, the first conductor portions and the second conductor portion each have a layered structure, and hence the resonance phenomenon described above can stably occur in the metamaterial structure. In addition, even when the infrared heater is operated in a high-temperature range, the second barrier layer can suppress migration of the material for forming the second adhesive layer into the second body layer. Accordingly, the heat resistance of the infrared heater can be further improved, and infrared light having the maximum peak described above can be more stably emitted.

In one embodiment, the infrared heater 100 further includes a support substrate 5. The support substrate 5 is arranged on a side of the second conductor portion 2 opposite to the dielectric layer 1. In this way, the support substrate can stably support the metamaterial structure described above.

In one embodiment, the second conductor portion 2 further includes a third adhesive layer 3a and a third barrier layer 3b. The third adhesive layer 3a is in contact with the support substrate 5. The third barrier layer 3b is arranged between the third adhesive layer 3a and the second body layer 2c. The third barrier layer 3b is capable of barring a material for forming the third adhesive layer 3a from migrating into the second body layer 2c. According to such configuration, the second conductor portion can be sufficiently bonded to the support substrate, and even when the infrared heater is operated in a high-temperature range, the third barrier layer can suppress migration of the material for forming the third adhesive layer into the second body layer. Accordingly, the heat resistance of the infrared heater can be still further improved, and infrared light having the maximum peak described above can be still more stably emitted.

In one embodiment, the infrared heater 100 further includes a heating unit 6. The heating unit 6 is capable of heating the metamaterial structure 10. In the metamaterial structure 10, the resonance phenomenon described above may occur through heating with the heating unit 6. In this way, the infrared heater can stably emit the infrared light described above.

In the illustrated example, the heating unit 6 is arranged on a side of the support substrate 5 opposite to the second conductor portion 2. Accordingly, the heating unit can smoothly heat the metamaterial structure through the support substrate.

The infrared heater 100 has an any appropriate shape when viewed from the thickness direction of the dielectric layer 1. Examples of the shape of the infrared heater viewed from the thickness direction include a triangular shape, a quadrilateral shape, a pentagonal shape, a polygonal shape with six or more sides, a circular shape, and an elliptical shape.

Details of each configuration of the infrared heater are described below.

### B. Dielectric Layer

The dielectric layer 1 is arranged between the conductor pattern 4 including the plurality of first conductor portions 41, and the second conductor portion 2. In the illustrated example, the dielectric layer 1 is in direct contact with each of the first conductor portions 41 and the second conductor portion 2.

An example of the material for forming the dielectric layer 1 is any appropriate inorganic oxide capable of forming a metamaterial structure. Examples of the inorganic oxide include silica (SiO₂) and alumina (Al₂O₃), and alumina is preferred. The inorganic oxides may be used alone or in combination thereof.

A thickness d of the dielectric layer 1 is, for example, 30 nm or more, preferably 100 nm or more, more preferably 150 nm or more. Meanwhile, the thickness d of the dielectric layer 1 is, for example, 300 nm or less, preferably 250 nm or less, more preferably 210 nm or less. When the thickness of the dielectric layer falls within such ranges, the peak wavelength of the infrared light can be stably adjusted to the above-mentioned ranges.

### C. Conductor Pattern Including Plurality of First Conductor Portions

Typically, the conductor pattern 4 is arranged directly on a surface of the dielectric layer 1 on a side opposite to the second conductor portion 2. The conductor pattern 4 has any appropriate pattern shape capable of forming a metamaterial structure. The conductor pattern 4 includes the plurality of first conductor portions 41 as described above. The plurality of first conductor portions 41 each typically have electrical conductivity.

The plurality of first conductor portions 41 are arrayed on the dielectric layer 1 so as to be spaced apart from each other to form a periodic structure. More specifically, rows each including the plurality of first conductor portions 41 arranged in a first plane direction of the dielectric layer 1 so as to be spaced apart from each other at equal intervals are arranged in parallel at equal intervals in a second plane direction, which is perpendicular to the first plane direction (see FIG. 2).

In the plane direction (the first plane direction or the second plane direction) of the dielectric layer, the distance between adjacent first conductor portions 41 among the plurality of first conductor portions 41 is, for example, 300 nm or more, or for example, 500 nm or more, or for example, 1,000 nm or more. Meanwhile, the distance between adjacent first conductor portions 41 is, for example, 8,000 nm or less, or for example, 5,000 nm or less, or for example, 4,000 nm or less.

The plurality of first conductor portions 41 may each typically have any appropriate shape capable of forming a metamaterial structure. Examples of the shape of each of the first conductor portions 41 viewed from the thickness direction include a circular shape and a rectangular shape (quadrilateral shape). A rectangular shape is preferred, and a square shape is more preferred.

A dimension of each of the first conductor portions 41 in the plane direction (the first plane direction or the second plane direction) of the dielectric layer may be optionally and appropriately adjusted in accordance with a desired peak wavelength. When the first conductor portions 41 each have a rectangular shape, a length (width) W of a side of each of the first conductor portions 41 is, for example, 500 nm or more, or for example, 1,000 nm or more. Meanwhile, the length (width) W of a side of each of the first conductor portions 41 is, for example, 8,000 nm or less, or for example, 4,000 nm or less.

When the first conductor portions 41 each have a circular shape, a diameter (width) of each of the first conductor portions 41 falls within the same ranges as those for the width W described above, for example.

The shapes and sizes of the plurality of first conductor portions 41 may all be the same, or may be at least partially different. It is preferred that the shapes and sizes of the plurality of first conductor portions 41 be all the same.

A pitch Λ of the periodic structure formed by the plurality of first conductor portions 41 is the sum of the distance between adjacent first conductor portions 41 and the width W of each of the first conductor portions 41. The pitch Λ may be optionally and appropriately adjusted in accordance with a desired peak wavelength. The pitch Λ is, for example, 500 nm or more, or for example, 1,000 nm or more. Meanwhile, the pitch Λ is, for example, 8,000 nm or less, or for example, 4,000 nm or less.

When the pitch Λ falls within such ranges, angle dependence of the infrared heater can be suitably adjusted.

A thickness h of each of the first conductor portions 41 is, for example, 30 nm or more, preferably 50 nm or more. Meanwhile, the thickness h of each of the first conductor portions 41 is, for example, 200 nm or less, preferably 150 nm or less, more preferably 100 nm or less. When the thickness of each of the first conductor portions falls within such ranges, the peak wavelength of the infrared light can be more stably adjusted to the above-mentioned ranges.

### C-1. First Adhesive Layer

The plurality of first conductor portions 41 each include the first adhesive layer 41a, the first barrier layer 41b, and the first body layer 41c as described above.

The first adhesive layer 41a typically bonds the first conductor portions 41 to the dielectric layer 1. In this way, adhesiveness of the first conductor portions to the dielectric layer can be improved, and peeling of the first conductor portions from the dielectric layer can be suppressed.

The first adhesive layer 41a may be formed of any appropriate metal material. Examples of the metal material for forming the first adhesive layer 41a include chromium (Cr), nickel (Ni), titanium (Ti), and an alloy thereof, and titanium (Ti) is preferred.

The thickness of the first adhesive layer 41a is, for example, 0.2 nm or more, preferably 3.0 nm or more. When the first adhesive layer has such thickness, adhesiveness of the first conductor portions to the dielectric layer can be stably improved. Meanwhile, the thickness of the first adhesive layer 41a is, for example, 30 nm or less, preferably 20 nm or less, more preferably 10 nm or less, still more preferably 8.0 nm or less.

### C-2. First Barrier Layer

In one embodiment, the first barrier layer 41b is directly arranged on a surface of the first adhesive layer 41a on a side opposite to the dielectric layer 1. The first barrier layer 41b is typically arranged on the entire surface of the first adhesive layer 41a on a side opposite to the dielectric layer 1. In this way, migration of the material for forming the first adhesive layer into the first body layer can be more stably barred.

The first barrier layer 41b may be formed of any appropriate metal material. Examples of the metal material for forming the first barrier layer 41b include platinum group elements and oxides thereof. Specific examples of the platinum group elements include platinum (Pt), palladium (Pd), and ruthenium (Ru). Platinum (Pt) and palladium (Pd) are preferred, and platinum (Pt) is more preferred. The metal material for forming the first barrier layer 41b may be an alloy of two or more kinds of platinum group elements.

The thickness of the first barrier layer 41b is, for example, 0.2 nm or more, more preferably 1.0 nm or more, still more preferably 3.0 nm or more. When the first barrier layer has such thickness, migration of the material for forming the first adhesive layer into the first body layer can be stably suppressed.

Meanwhile, the thickness of the first barrier layer 41b is, for example, 50 nm or less, more preferably 30 nm or less, still more preferably 20 nm or less, especially preferably 15 nm or less, particularly preferably 10 nm or less, most preferably 8.0 nm or less. When the first barrier layer has such thickness, an influence of the first barrier layer on the resonance phenomenon occurring in the metamaterial structure can be suppressed, and the infrared light having the maximum peak described above can be stably emitted.

In addition, when the thickness of the first barrier layer is such upper limit or less, growth of grains in the first barrier layer can be suppressed even when the infrared heater is exposed to high temperature over a long period of time.

When grains grow in the first barrier layer, the pattern shape of the first conductor portions may be distorted (deformed), and the maximum emissivity of the infrared light emitted from the infrared heater may decrease.

In contrast, in one embodiment, growth of grains in the first barrier layer is sufficiently suppressed. Thus, even when the infrared heater is exposed to high temperature for a long period of time, distortion (deformation) of the pattern shape of the first conductor portions can be suppressed, and a decrease in maximum emissivity of the infrared light emitted from the infrared heater can be sufficiently suppressed. As a result, further improvement in heat resistance of the infrared heater can be achieved.

The thickness of the first barrier layer 41b is typically equal to or larger than the thickness of the first adhesive layer 41a. That is, a ratio (thickness of first barrier layer/thickness of first adhesive layer) of the thickness of the first barrier layer 41b to the thickness of the first adhesive layer 41a is, for example, 1.0 or more. Meanwhile, the ratio (thickness of first barrier layer/thickness of first adhesive layer) is, for example, 10 or less, preferably 5.0 or less, more preferably 2.0 or less.

The thickness of the first barrier layer 41b is typically less than the thickness of the first body layer 41c. That is, a ratio (thickness of first barrier layer/thickness of first body layer) of the thickness of the first barrier layer 41b to the thickness of the first body layer 41c is, for example, 0.02 or more, preferably 0.05 or more. Meanwhile, the ratio (thickness of first barrier layer/thickness of first body layer) is, for example, 0.50 or less, preferably 0.30 or less, more preferably 0.15 or less.

### C-3. First Body Layer

In one embodiment, the first body layer 41c is directly arranged on a surface of the first barrier layer 41b on a side opposite to the first adhesive layer 41a. The first body layer 41c is typically arranged on the entire surface of the first barrier layer 41b on a side opposite to the first adhesive layer 41a.

The first body layer 41c may be formed of any appropriate metal material. Examples of the metal material for forming the first body layer 41c include a low-melting point material having a melting point of less than 2,500° C., a high-melting point material having a melting point of 2,500° C. or more, and an alloy thereof.

Examples of the low-melting point material include gold (Au, melting point: 1,064° C.), silver (Ag, melting point: 962° C.), copper (Cu, melting point: 1,085° C.), iron (Fe, melting point: 1,538° C.), aluminum (Al, melting point: 660° C.), and an alloy thereof, and gold (Au) is preferred.

Examples of the high-melting point material include iridium (Ir, melting point: 2,466° C.), ruthenium (Ru, melting point: 2,334° C.), hafnium nitride (HAN, melting point: 3,334° C.), titanium nitride (TiN, melting point: 2,930° C.), and an alloy thereof. When the first body layer contains a high-melting point material, growth of grains in the first body layer can be suppressed. Accordingly, even when the infrared heater is exposed to high temperature for a long period of time, distortion (deformation) of the pattern shape of the first conductor portions can be still further suppressed.

The thickness of the first body layer 41c is, for example, 30 nm or more and 200 nm or less, preferably 50 nm or more and 110 nm or less.

### D. Second Conductor Portion

The second conductor portion 2 is typically arranged directly on a surface of the dielectric layer 1 on a side opposite to the conductor pattern 4. The second conductor portion 2 has electrical conductivity. The second conductor portion 2 may be arranged on the entire surface of the dielectric layer 1 on a side opposite to the conductor pattern 4, or may be arranged only on part of the surface thereof. In the illustrated example, the second conductor portion 2 is arranged in a layered form on the entire surface of the dielectric layer 1 on a side opposite to the conductor pattern 4.

The second conductor portion 2 may have a single layer structure or may have a layered structure in which a plurality of metal films are layered. An example of a material for forming the second conductor portion 2 is any appropriate metal material capable of forming a metamaterial structure. Examples of the metal material include chromium (Cr), titanium (Ti), ruthenium (Ru), gold (Au), aluminum (Al), nickel (Ni), copper (Cu), silver (Ag), palladium (Pd), and an alloy thereof.

A thickness f of the second conductor portion 2 is, for example, 30 nm or more and 500 nm or less, preferably 50 nm or more and 300 nm or less. When the second conductor portion has such thickness, the resonance phenomenon described above can stably occur in the metamaterial structure.

In the illustrated example, the second conductor portion 2 has a layered structure and includes the second adhesive layer 2a, the second barrier layer 2b, the second body layer 2c, the third barrier layer 3b, and the third adhesive layer 3a.

The second adhesive layer 2a typically bonds the second conductor portion 2 to the dielectric layer 1. In this way, adhesiveness of the second conductor portion to the dielectric layer can be improved, and peeling of the second conductor portion from the dielectric layer can be suppressed. The second adhesive layer 2a may be described similarly to the first adhesive layer 41a described above. Accordingly, the description of the second adhesive layer 2a is omitted. A metal material for forming the second adhesive layer 2a is preferably the same as the metal material for forming the first adhesive layer 41a. The thickness of the second adhesive layer 2a is preferably the same as the thickness of the first adhesive layer 41a.

In one embodiment, the second barrier layer 2b is directly arranged on a surface of the second adhesive layer 2a on a side opposite to the dielectric layer 1. The second barrier layer 2b is typically arranged on the entire surface of the second adhesive layer 2a on a side opposite to the dielectric layer 1. In this way, migration of the material for forming the second adhesive layer into the second body layer can be more stably suppressed. The second barrier layer 2b may be described similarly to the first barrier layer 41b described above. Accordingly, the description of the second barrier layer 2b is omitted. A metal material for forming the second barrier layer 2b is preferably the same as the metal material for forming the first barrier layer 41b. The thickness of the second barrier layer 2b is preferably the same as the thickness of the first barrier layer 41b.

In one embodiment, the second body layer 2c is directly arranged on a surface of the second barrier layer 2b on a side opposite to the second adhesive layer 2a. The second body layer 2c is typically arranged on the entire surface of the second barrier layer 2b on a side opposite to the second adhesive layer 2a. The second body layer 2c may be described similarly to the first body layer 41c described above. Accordingly, the description of the second body layer 2c is omitted. A metal material for forming the second body layer 2c is preferably the same as the metal material for forming the first body layer 41c. The thickness of the second body layer 2c is preferably the same as the thickness of the first body layer 41c.

In one embodiment, the third adhesive layer 3a is arranged directly on a surface of the support substrate 5 on the second conductor portion 2 side. The third adhesive layer 3a may be arranged on the entire surface of the support substrate 5 on the second conductor portion 2 side, or may be arranged only on part of the surface thereof. In the illustrated example, the third adhesive layer 3a is arranged on the entire surface of the support substrate 5.

The third adhesive layer 3a typically bonds the second conductor portion 2 to the support substrate 5. In this way, adhesiveness of the second conductor portion to the support substrate can be improved, and peeling of the second conductor portion from the support substrate can be suppressed. The third adhesive layer 3a may be described similarly to the first adhesive layer 41a described above. Accordingly, the description of the third adhesive layer 3a is omitted. A metal material for forming the third adhesive layer 3a is preferably the same as the metal material for forming the first adhesive layer 41a. The thickness of the third adhesive layer 3a is preferably the same as the thickness of the first adhesive layer 41a.

In one embodiment, the third barrier layer 3b is arranged directly on a surface of the third adhesive layer 3a on a side opposite to the support substrate 5 and is in contact with the second body layer 2c. The third barrier layer 3b is typically arranged on the entire surface of the third adhesive layer 3a on a side opposite to the support substrate 5. In this way, migration of the material for forming the third adhesive layer into the second body layer can be more stably suppressed. The third barrier layer 3b may be described similarly to the first barrier layer 41b described above. Accordingly, the description of the third barrier layer 3b is omitted. A metal material for forming the third barrier layer 3b is preferably the same as the metal material for forming the first barrier layer 41b. The thickness of the third barrier layer 3b is preferably the same as the thickness of the first barrier layer 41b.

### E. Support Substrate

The support substrate 5 can impart excellent mechanical strength to the infrared heater 100. Any appropriate substrate capable of being used in an infrared heater may be adopted as the support substrate 5. The support substrate 5 typically has a substantially flat plate shape.

An example of a material for forming the support substrate 5 is a material excellent in heat resistance. Specific examples thereof include sapphire, silicon (Si), and quartz, and quartz is preferred.

The support substrate 5 may have a single layer structure or may have a layered structure in which a plurality of substrates are layered.

The thickness of the support substrate 5 is, for example, 100 μm or more and 1,000 μm or less, or for example, 50 μm or more and 700 μm or less.

### F. Heating Unit

The heating unit 6 is typically in contact with a surface of the support substrate 5 on a side opposite to the second conductor portion 2. The heating unit 6 is capable of heating the metamaterial structure 10 as described above. A heating temperature of the heating unit 6 is, for example, 200° C. or more and 800° C. or less, preferably 650° C. or more and 800° C. or less.

The configuration of the heating unit 6 is not particularly limited. Any appropriate heat generation unit may be adopted as the heating unit.

In one embodiment, the heating unit 6 is formed as a planar heater. In the illustrated example, the heating unit 6 includes a base body 62 and a heat generator 61.

The base body 62 is typically formed of an insulating material. Examples of the insulating material include an insulating resin such as polyimide and an insulating ceramic material. In the illustrated example, the base body 62 has a substantially flat plate shape.

The heat generator 61 is typically embedded in the base body 62. In one embodiment, the heat generator 61 is a resistance heat generator and generates heat when electric power is applied from the outside. The heat generator 61 includes heater wiring and a terminal (both not shown). The heater wiring typically has a linear or band shape. The heater wiring is optionally and appropriately led inside the base body 62. The terminal is arranged in each of two end portions of the heater wiring. Typically, the terminal is electrically connected to an external power source. Examples of a material for the heat generator 61 include tungsten (W), molybdenum (Mo), tantalum (Ta), a (Ta,Fe)—Cr—Al alloy, and a Ni—Cr alloy.

### G. Infrared Heater Production Method

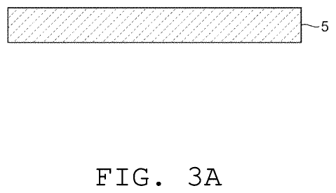

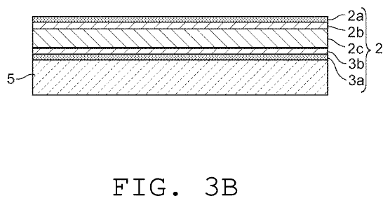

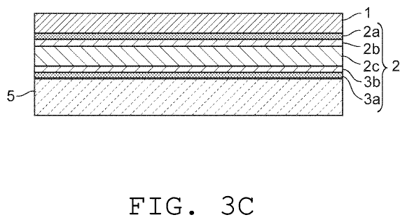

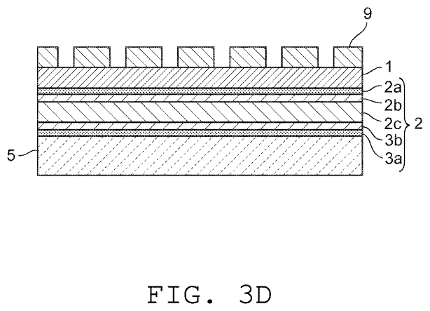

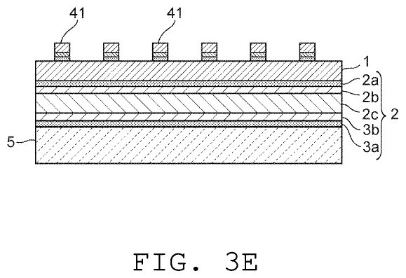

Next, one embodiment of a method of producing the infrared heater 100 is described with reference to FIG. 3A to FIG. 3E.

First, as illustrated in FIG. 3A, the support substrate 5 described above is prepared. Then, as illustrated in FIG. 3B, the second conductor portion 2 described above is formed on the support substrate 5, as required. Typically, the second conductor portion 2 is formed on the support substrate 5 through film formation. Examples of a film formation method for forming the second conductor portion 2 include sputtering, plating, and vapor deposition, and sputtering is preferred. In the illustrated example, the second conductor portion 2 includes the second adhesive layer 2a, the second barrier layer 2b, the second body layer 2c, the third barrier layer 3b, and the third adhesive layer 3a. In this case, the above-mentioned film formation method is repeated to form the third adhesive layer 3a, the third barrier layer 3b, the second body layer 2c, the second barrier layer 2b, and the second adhesive layer 2a in this order from the support substrate 5 side.

Next, as illustrated in FIG. 3C, the dielectric layer 1 described above is formed on the second conductor portion 2. Typically, the dielectric layer 1 is formed on the second conductor portion 2. In the illustrated example, the dielectric layer 1 is formed on the second adhesive layer 2a. Examples of a method of forming the dielectric layer 1 include sputtering and an atomic layer deposition (ALD) method.

Next, as illustrated in FIG. 3D and FIG. 3E, the conductor pattern 4 including the plurality of first conductor portions 41 as described above is formed on the dielectric layer 1.

In one embodiment, as illustrated in FIG. 3D, a resist pattern 9 is formed on the dielectric layer 1. Examples of a method of forming the resist pattern 9 include photolithography, nanoimprint lithography, and maskless lithography using electron beam (EB) printing, and photolithography is preferred. In this way, openings corresponding to the plurality of first conductor portions 41 can be accurately formed in the resist pattern 9. A size of each of the openings corresponds to the width W of each of the first conductor portions 41 described above.

Next, as illustrated in FIG. 3E, the plurality of first conductor portions 41 described above are formed by any appropriate film formation method in portions of the dielectric layer 1 not covered by the resist pattern 9. Examples of a film formation method for forming the first conductor portions 41 include sputtering, plating, and vapor deposition, and vapor deposition is preferred. More specifically, the above-mentioned film formation method is repeated to form the first adhesive layer 41a, the first barrier layer 41b, and the first body layer 41c in this order from the dielectric layer 1 side.

Next, the resist pattern 9 is removed by any appropriate method.

In the above-mentioned manner, as illustrated in FIG. 1, the infrared heater 100 having the structure “conductor patten 4 including plurality of first conductor portions 41/dielectric layer 1/second conductor portion 2/support substrate 5” is produced.

### EXAMPLES

The present disclosure is specifically described below by way of Examples, but the present disclosure is not limited by these Examples.

### Examples 1 to 4

First, a quartz wafer having a thickness of 625 μm was prepared as a support substrate. A third adhesive layer, a third barrier layer, a second body layer, a second barrier layer, and a second adhesive layer were formed on the support substrate in this order by sputtering. In this manner, a second conductor portion including the second adhesive layer, the second barrier layer, the second body layer, the third barrier layer, and the third adhesive layer was formed. Metal materials for forming the second adhesive layer, the second barrier layer, the second body layer, the third barrier layer, and the third adhesive layer, respectively, and the thickness of each layer are shown in Table 1.

Next, a dielectric layer formed of alumina (Al₂O₃) was formed on the second adhesive layer by sputtering. The thickness of the dielectric layer is shown in Table 1.

Next, a resist pattern was formed on the dielectric layer by photolithography. The resist pattern had openings corresponding to a plurality of first conductor portions of a conductor pattern.

Next, in portions of the dielectric layer not covered by the resist pattern, a first adhesive layer, a first barrier layer, and a first body layer were formed in this order by vapor deposition. In this manner, the conductor pattern was formed on the dielectric layer.

The conductor pattern included the plurality of first conductor portions for forming a periodic structure. The plurality of first conductor portions each included the first body layer, the first barrier layer, and the first adhesive layer. Metal materials for forming the first body layer, the first barrier layer, and the first adhesive layer, respectively, and the thickness of each layer are shown in Table 1.

Each of the first conductor portions had a circular shape when viewed from the thickness direction. The diameter of each of the first conductor portions was 2.3 μm. The pitch of the plurality of first conductor portions was 4.3 μm.

After that, the resist pattern was removed.

In this manner, an infrared heater having the structure “conductor patten including plurality of first conductor portions/dielectric layer/second conductor portion/support substrate” was obtained.

### «Heat Durability Test»

The obtained infrared heater was subjected to a heat durability test. More specifically, the infrared heater was placed in a heating furnace and left to stand still at 650° C. for the period of time shown in Table 1. “0 hr” in Table 1 means the time of the start of the heat durability test (i.e., before heating). In addition, “10 hr×5” in Table 1 means that a cycle involving placing the infrared heater in the heating furnace to heat the heater at 650° C. for 10 hours, and then taking out the heater from the heating furnace to cool to room temperature (23° C.) was repeated five times.

Then, the infrared heater after the heat durability test shown in Table 1 was caused to emit infrared light from the emitting surface of the dielectric layer at room temperature. The normal-incidence hemispherical reflectance of the infrared light was measured in the wavelength range of from 2.0 μm to 12.0 μm with a Fourier transform infrared spectrophotometer (FT-IR) equipped with an integrating sphere, and a normal emissivity was calculated by the formula (1). The maximum normal emissivity of the infrared light is shown in Table 1.

In addition, in FIG. 4, the infrared emissivity curve of the infrared heater of Example 2 at “0 hr” is represented by a dotted line, and the infrared emissivity curve of the infrared heater of Example 2 after “10 hr×5” is represented by a solid line. The infrared emissivity curve is obtained by plotting the normal emissivity of the infrared light emitted by each infrared heater verses the wavelength of the infrared light.

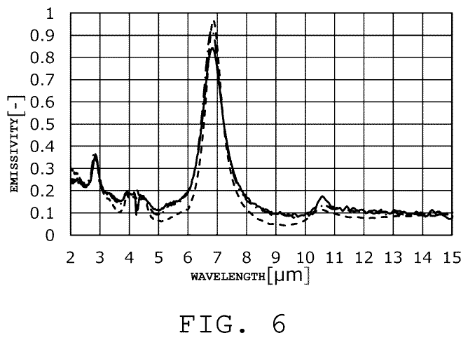

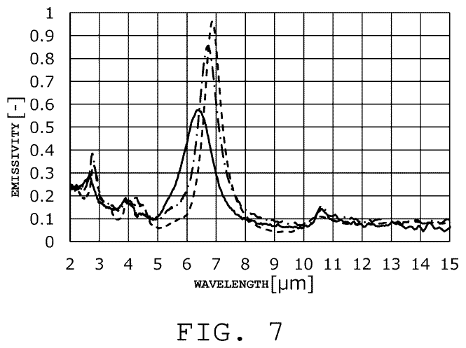

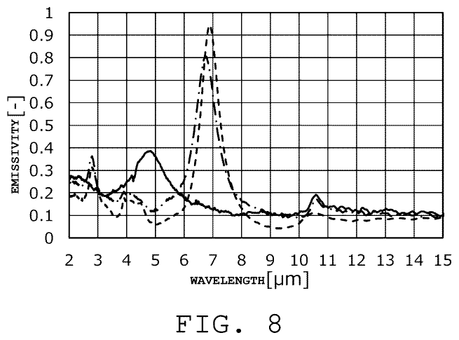

Further, the infrared emissivity curves of the infrared heater of Example 2 are shown in FIG. 6, the infrared emissivity curves of the infrared heater of Example 3 are shown in FIG. 7, and the infrared emissivity curves of the infrared heater of Example 4 are shown in FIG. 8. In each of FIG. 6 to FIG. 8, the infrared emissivity curve of the infrared heater at “0 hr” is represented by a dotted line, the infrared emissivity curve of the infrared heater after “100 hr” is represented by a dash-dotted line, and the infrared emissivity curve of the infrared heater after “500 hr” is represented by a solid line.

### Comparative Examples 1 to 3

A quartz wafer having a thickness of 625 μm was prepared as a support substrate. A third adhesive layer, a second body layer, and a second adhesive layer were formed on the support substrate in this order by sputtering. In this manner, a second conductor portion that included the second adhesive layer, the second body layer, and the third adhesive layer and was free of a second barrier layer was formed. Metal materials for forming the second adhesive layer, the second body layer, and the third adhesive layer, respectively, and the thickness of each layer are shown in Table 2.

Next, a dielectric layer formed of alumina (Al₂O₃) was formed on the second adhesive layer by sputtering. The thickness of the dielectric layer is shown in Table 2.

Next, a resist pattern was formed on the dielectric layer by photolithography. The resist pattern had openings corresponding to a plurality of first conductor portions of a conductor pattern.

Next, in portions of the dielectric layer not covered by the resist pattern, a first adhesive layer and a first body layer were formed in this order by vapor deposition. In this manner, the conductor pattern was formed on the dielectric layer. The conductor pattern included the plurality of first conductor portions for forming a periodic structure. Each of the first conductor portions included the first adhesive layer and the first body layer and was free of the first barrier layer. Metal materials for forming the first body layer and the first adhesive layer, respectively, and the thickness of each layer are shown in Table 2.

Each of the first conductor portions had a circular shape when viewed from the thickness direction. The diameter of each of the first conductor portions was 2.3 μm. The pitch of the plurality of first conductor portions was 4.3 μm.

After that, the resist pattern was removed.

In this manner, an infrared heater including the first conductor portions and the second conductor portion each free of a barrier layer was obtained. The infrared heater was subjected to the heat durability test described above. The results are shown in Table 2.

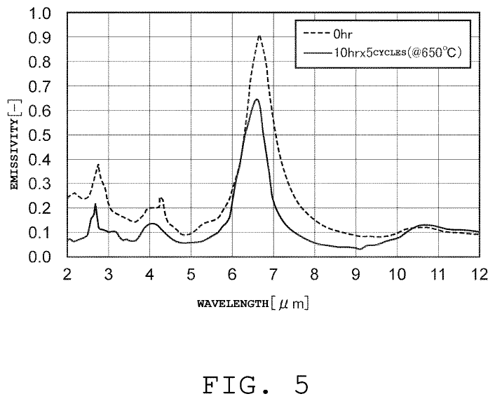

In addition, in FIG. 5, the infrared emissivity curve of the infrared heater of Comparative Example 2 at “0 hr” is represented by a dotted line, and the infrared emissivity curve of the infrared heater of Comparative Example 2 after “10 hr×5” is represented by a solid line.

TABLE 1

| | | | | Example | Example | Example | Example |
|---|---|---|---|---|---|---|---|
| No. | | | | 1 | 2 | 3 | 4 |
| First | First body | Material | | Au | | | |
| conductor | layer | Thickness [μm] | | 80 | | | |
| portion | First barrier | Material | | Pd | Pt | Pt | Pt |
| | layer | Thickness [μm] | | 20 | 5.0 | 10 | 20 |
| | First adhesive | Material | | Ti | Ti | Ti | Ti |
| | layer | Thickness [nm] | | 5.0 | 5.0 | 5.0 | 5.0 |
| Dielectric | Material | | | Al₂O₃ | | | |
| layer | Thickness [nm] | | | 180 | | | |
| Second | Second | Material | | Ti | Ti | Ti | Ti |
| conductor | adhesive | Thickness [μm] | | 5.0 | 5.0 | 5.0 | 5.0 |
| portion | layer | | | | | | |
| | Second | Material | | Pd | Pt | Pt | Pt |
| | barrier layer | Thickness [μm] | | 20 | 5.0 | 10 | 20 |
| | Second | Material | | Au | | | |
| | body layer | Thickness [nm] | | 80 | | | |
| | Third barrier | Material | | Pd | Pt | Pt | Pt |
| | layer | Thickness [μm] | | 20 | 5.0 | 10 | 20 |
| | Third | Material | | Ti | Ti | Ti | Ti |
| | adhesive | Thickness [μm] | | 5.0 | 5.0 | 5.0 | 5.0 |
| | layer | | | | | | |
| Evaluation | Heat | 0 hr | Maximum | 0.89 | 0.97 | 0.97 | 0.92 |
| | durability | 0.5 hr | normal | 0.93 | — | — | — |
| | test | 10 hr | emissivity | 0.95 | — | — | — |
| | (650° C.) | 10 hr × 5 | [—] | 0.88 | 0.88 | 0.88 | 0.88 |
| | | 100 hr | | — | 0.92 | 0.85 | 0.80 |
| | | 500 hr | | — | 0.84 | 0.57 | 0.39 |

| | | | | |
|---|---|---|---|---|
| Heat resistance | ○ | ○ | ○ | ○ |

TABLE 2

| | | | | Comparative | Comparative | Comparative |
|---|---|---|---|---|---|---|
| No. | | | | Example 1 | Example 2 | Example 3 |
| First | First body | Material | | Au | | |
| conductor | layer | Thickness [μm] | | 80 | | |
| portion | First barrier | Material | | — | — | — |
| | layer | Thickness [μm] | | — | — | — |
| | First adhesive | Material | | Cr | Cr | Ti |
| | layer | Thickness [nm] | | 20 | 5.0 | 5.0 |
| Dielectric | Material | | | Al₂O₃ | | |
| layer | Thickness [nm] | | | 180 | | |
| Second | Second | Material | | Cr | Cr | Ti |
| conductor | adhesive | Thickness [μm] | | 20 | 5.0 | 5.0 |
| portion | layer | | | | | |
| | Second | Material | | — | — | — |
| | barrier layer | Thickness [μm] | | — | — | — |
| | Second | Material | | Au | | |
| | body layer | Thickness [nm] | | 80 | | |
| | Third | Material | | — | — | — |
| | barrier layer | Thickness [μm] | | — | — | — |
| | Third | Material | | Cr | Cr | Ti |
| | adhesive layer | Thickness [μm] | | 20 | 5.0 | 5.0 |
| Evaluation | Heat | 0 hr | Maximum | 0.96 | 0.92 | 0.92 |
| | durability | 0.5 hr | normal | 0.70 | 0.91 | 0.83 |
| | test | 10 hr | emissivity | — | — | — |
| | (650° C.) | 10 hr × 5 | [—] | | 0.91 | 0.83 |
| | | 100 hr | | — | — | — |
| | | 500 hr | | — | 0.65 | 0.78 |

| | | | |
|---|---|---|---|
| Heat resistance | x | x | x |

### <Evaluation>

As shown in Table 1 to Table 2 and FIG. 4 to FIG. 8, it has been recognized that the infrared heaters (Examples 1 to 4) each including the first barrier layer between the first adhesive layer and the first body layer have excellent heat resistance as compared to the infrared heaters (Comparative Examples 1 to 3) each free of a barrier layer. More specifically, in the case of the infrared heater of each of Comparative Examples 1 to 3, when the 10-hour heat durability test at 650° C. is repeated five times, the maximum normal emissivity is less than 0.8. In contrast, in the case of the infrared heater of each of Examples 1 to 4, even when the 10-hour heat durability test at 650° C. is repeated five times, the maximum normal emissivity is 0.8 or more, and the infrared heater is found to have excellent heat resistance.

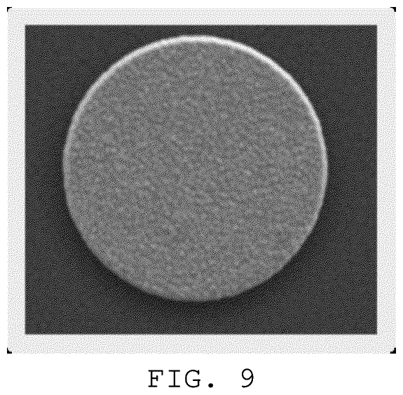

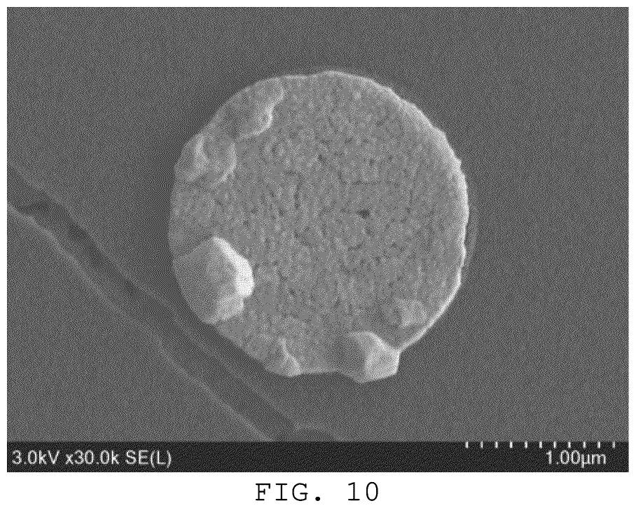

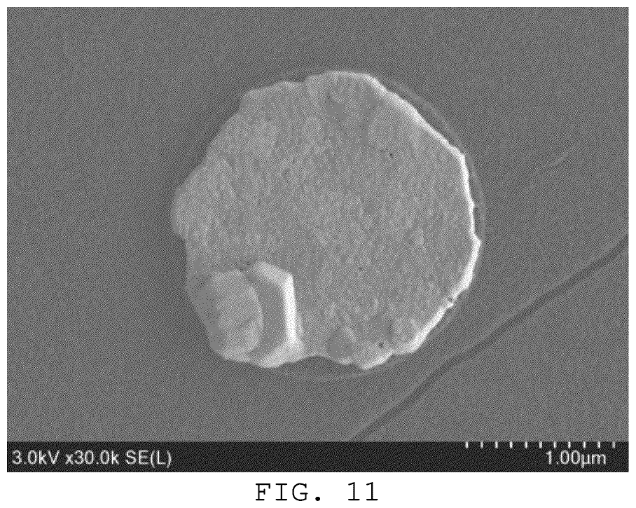

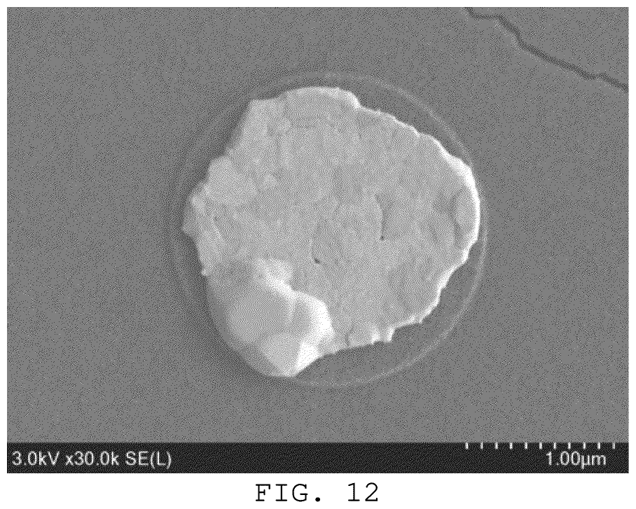

In particular, it is recognized that the infrared heater of Example 2 exhibits a maximum normal emissivity of 0.8 or more even after having been subjected to the 500-hour heat durability test at 650° C. In view of the foregoing, regarding each of the infrared heaters of Examples 2 to 4, the shape of a first conductor portion after the 500-hour heat durability test at 650° C. was observed with a scanning electron microscope (SEM). The SEM photographs thereof are shown in FIG. 10 to FIG. 12. In addition, for comparison, a SEM photograph of a first conductor portion of the infrared heater of Example 2 before the heat durability test is shown in FIG. 9. The magnification of each of the SEM photographs is 30,000 times.

As is apparent from FIG. 9 to FIG. 12, growth of grains during the heat durability test is suppressed, and deformation of the pattern shape of the first conductor portion is suppressed in Example 2 as compared to Examples 3 and 4.

The infrared heater according to the embodiment of the present disclosure can be used in production of various industrial products, and can be suitably used in production of film products, organic synthesis products, and the like, in particular.

What is claimed is:

1. An infrared heater, comprising:
a dielectric layer;
a conductor pattern arranged on the dielectric layer, the conductor pattern including a plurality of first conductor portions arrayed so as to be spaced apart from each other to form a periodic structure; and
a second conductor portion arranged on a side of the dielectric layer opposite to the conductor pattern,
wherein the plurality of first conductor portions each include:
a first adhesive layer in contact with the dielectric layer;
a first body layer arranged on a side of the first adhesive layer opposite to the dielectric layer; and
a first barrier layer arranged between the first adhesive layer and the first body layer, the first barrier layer being configured to bar a material for forming the first adhesive layer from migrating into the first body layer.

2. The infrared heater according to claim 1, wherein the first barrier layer has a thickness of 0.2 nm or more and 50 nm or less.

3. The infrared heater according to claim 1, wherein a material for forming the first barrier layer contains a platinum group element and/or an oxide thereof.

4. The infrared heater according to claim 1, wherein the second conductor portion includes:
a second adhesive layer in contact with the dielectric layer;
a second body layer arranged on a side of the second adhesive layer opposite to the dielectric layer; and
a second barrier layer arranged between the second adhesive layer and the second body layer, the second barrier layer being configured to bar a material for forming the second adhesive layer from migrating into the second body layer.

5. The infrared heater according to claim 4, further comprising a support substrate arranged on a side of the second conductor portion opposite to the dielectric layer.

6. The infrared heater according to claim 5, wherein the second conductor portion includes:
a third adhesive layer in contact with the support substrate; and
a third barrier layer arranged between the third adhesive layer and the second body layer, the third barrier layer being configured to bar a material for forming the third adhesive layer from migrating into the second body layer.

7. The infrared heater according to claim 1,
wherein the plurality of first conductor portions each have a thickness of 30 nm or more and 200 nm or less,
wherein, when the plurality of first conductor portions each have a rectangular shape when viewed from a thickness direction, the plurality of first conductor portions each have a side with a length of 500 nm or more and 8,000 nm or less, and
wherein, when the plurality of first conductor portions each have a circular shape when viewed from the thickness direction, the plurality of first conductor portions each have a diameter of 500 nm or more and 8,000 nm or less.

8. The infrared heater according to claim 1, wherein a distance between adjacent first conductor portions among the plurality of first conductor portions is 300 nm or more and 4,000 nm or less.

9. The infrared heater according to claim 1, further comprising a heating unit capable of heating a metamaterial structure including the dielectric layer, the plurality of first conductor portions, and the second conductor portion.

10. The infrared heater according to claim 9,
wherein the metamaterial structure is configured such that a resonance phenomenon based on magnetic polariton occurs through heating with the heating unit,
wherein the infrared heater is capable of emitting infrared light having a maximum peak of a normal emissivity of 0.8 or more,
wherein a peak wavelength of the maximum peak is 2 μm or more and 10 μm or less, and
wherein a half width of the maximum peak is 1.5 μm or less.
